(19) United States
(12) Patent Application Publication
(10) Pub. No.: US 2016/0082369 A1
(43) Pub. Date: Mar. 24, 2016

(54) FILTER ELEMENT AND FILTER ASSEMBLY FOR SEPARATING FLUIDS

(71) Applicant: Caterpillar Inc., Peoria, IL (US)

(72) Inventors: Bryant A. MORRIS, PEORIA, IL (US); JEFFREY R. RIES, METAMORA, IL (US); DARRELL L. MOREHOUSE, III, DUNLAP, IL (US)

(73) Assignee: Caterpillar Inc., Peoria, IL (US)

(21) Appl. No.: 14/490,996

(22) Filed: Sep. 19, 2014

(51) Int. Cl. B01D 35/00; B01D 17/04

(52) U.S. Cl. CPC B01D 35/005; B01D 17/045

(57) ABSTRACT

A filter element may include an outer tubular member and an inner tubular member at least partially inside the outer tubular member. The filter element may also include a first cap and a second cap coupled to respective first and second ends of the outer tubular member. The filter element may further include filter media configured to promote separation of a first fluid from a second fluid. The filter media may extend between the first cap and the second cap. The first cap may be configured such that fluid entering the filter element flows between the inner tubular member and the outer tubular member, and through the filter media. The filter element may be configured such that a portion of the fluid may flow from a first side of the second cap to a second side of the second cap, but not into the inner tubular member.

### TECHNICAL FIELD

The present disclosure relates to a filter element and filter assembly, and more particularly, to a filter element and filter assembly for separating fluids.

### BACKGROUND

Engines, including compression-ignition engines, spark-ignition engines, gasoline engines, gaseous fuel-powered engines, and other internal combustion engines, may operate more effectively with fuel from which contaminates have been removed prior to the fuel reaching a combustion chamber of the engine. In particular, fuel contaminates, if not removed, may lead to undesirable operation of the engine and/or may increase the wear rate of engine components, such as, for example, fuel system components.

Effective removal of contaminates from the fuel system of a compression-ignition engine may be particularly important. In some compression-ignition engines, air is compressed in a combustion chamber, thereby increasing the temperature and pressure of the air, such that when fuel is supplied to the combustion chamber, the fuel and air mixture ignite. If water and/or other contaminates are not removed from the fuel, the contaminates may interfere with and/or damage, for example, fuel injectors, which may have orifices manufactured to exacting tolerances and shapes for improving the efficiency of combustion and/or reducing undesirable exhaust emissions. Moreover, the presence of water in the fuel system may cause considerable engine damage and/or corrosion in the injection system.

Fuel filtration systems serve to remove contaminates from the fuel. For example, some conventional fuel systems may include a fuel filter, which removes water and large particulate matter, and another fuel filter, which removes a significant portion of remaining particulate matter (e.g., smaller contaminates), such as fine particulate matter. However, water may be particularly difficult to separate from fuel under certain circumstances. For example, if water is emulsified in the fuel it may be relatively more difficult to separate from fuel. In addition, for some types of fuel, such as, for example, fuel having a bio-component, it may be relatively more difficult to separate the water from the fuel. Therefore, it may be desirable to provide a filter element and/or filter assembly with an improved ability to separate water from fuel.

An attempt to provide desired filtration is described in U.S. Patent Application Publication No. US 2013/0146524 A1 (“the '524 publication”) to Veit et al., published Jun. 13, 2013. Specifically, the '524 publication discloses a fuel filter having a housing with a fuel inlet, a fuel outlet for cleaned fuel, and a water outlet for water separated from the fuel. A filter element is arranged in the housing and separates the fuel inlet and fuel outlet. The filter element has a filter medium configured as a hollow member for filtering the fuel and a hydrophobic fuel-permeable separating medium embodied as a hollow member for separating water from the fuel. The separating medium is arranged downstream of the filter medium and is positioned inside the filter medium or surrounds the filter medium. Between the filter medium and the separating medium, a precipitation slot is provided having a conical shape and being connected with the water outlet.

Although the fuel filter of the '524 publication purports to separate water from fuel, it may not provide sufficient separation under circumstances where the fuel is emulsified or includes bio-components. Thus, it may not provide a desirable level of fuel filtration.

The filter element and filter assembly disclosed herein may be directed to mitigating or overcoming one or more of the possible drawbacks set forth above.

### SUMMARY

According to a first aspect, a filter element may include a canister having a longitudinal axis and extending between a first end and a second end. The filter element may also include a first cap coupled to the first end of the canister, and a second cap coupled to the second end of the canister. The filter element may further include an outer tubular member extending between the first cap and the second cap, with the outer tubular member including a plurality of outer apertures. The filter element may also include an inner tubular member at least partially inside the outer tubular member, with the inner tubular member including a plurality of inner apertures. The filter element may further include filter media configured to promote separation of a first fluid from a second fluid having different characteristics than the first fluid as fluid passes through the filter media. The filter media may extend between the first cap and the second cap and around an exterior surface of the outer tubular member, such that space exists between an exterior surface of the filter media and an interior surface of the canister. The filter element may be configured such that fluid entering the filter element flows between the interior surface of the canister and the exterior surface of the filter media and through the filter media, such that a portion of the fluid flows into the outer tubular member but not into the inner tubular member.

According to a further aspect, a filter assembly may include a filter base configured to be coupled to a machine, and a filter element. The filter element may include a canister having a longitudinal axis and extending between a first end and a second end. The filter element may further include a first cap coupled to the first end of the canister, and a second cap coupled to the second end of the canister. The filter element may also include an outer tubular member extending between the first cap and the second cap, with the outer tubular member including a plurality of outer apertures. The filter element may further include an inner tubular member at least partially inside the outer tubular member, with the inner tubular member including a plurality of inner apertures. The filter element may also include filter media configured to promote separation of a first fluid from a second fluid having characteristics different than the first fluid as fluid passes through the filter media, wherein the filter media extends between the first cap and the second cap and around an exterior surface of the outer tubular member. The filter element may be configured such that a portion of the fluid flows into the outer tubular member but not into the inner tubular member. The filter assembly may further include a collection bowl coupled to the filter element and configured to receive the portion of fluid that flows into the outer tubular member but not into the inner tubular member.

According to another aspect, a method for separating a first fluid from a second fluid having different characteristics than the first fluid may include flowing a fluid including a first fluid and a second fluid from a filter base into a canister containing filter media configured to promote separation of the first fluid from the second fluid as the fluid passes through the filter media. The method may further include flowing the fluid through the filter media to separate at least a portion of the first fluid from the second fluid, and flowing the first fluid via an outer tubular member into a collection bowl configured to capture the first fluid. The method may further include flowing the second fluid via an inner tubular member out of the filter element and into the filter base.

According to another aspect, a filter element may include a canister having a longitudinal axis and extending between a first end and a second end. The filter element may also include a first cap coupled to the first end of the canister, with the first cap having a first inlet passage. The filter element may further include a second cap coupled to the second end of the canister, wherein at least one of the second cap and the canister are configured to provide flow communication from a first side of the second cap to a second side of the second cap opposite the first cap. The filter element may also include an outer tubular member extending between the first cap and the second cap, with the outer tubular member including a plurality of outer apertures. The filter element may further include an inner tubular member at least partially inside the outer tubular member, and filter media configured to promote separation of a first fluid from a second fluid having different characteristics than the first fluid as fluid passes through the filter media. The filter media may extend between the first cap and the second cap and around an exterior surface of the outer tubular member, such that space exists between an exterior surface of the filter media and an interior surface of the canister. The filter element may be configured such that fluid entering the filter element flows between an exterior surface of the inner tubular member and an interior surface of the outer tubular member, through at least some of the plurality of apertures in the outer tubular member, and through the filter media. The filter element may be configured such that a portion of the fluid may flow from the first side of the second cap to the second side of the second cap, but not into the inner tubular member.

According to another aspect, a filter assembly may include a filter base configured to be coupled to a machine, and a filter element. The filter element may include a canister having a longitudinal axis and extending between a first end and a second end, and a first cap coupled to the first end of the canister. The filter element may also include a second cap coupled to the second end of the canister, wherein at least one of the second cap and the canister are configured to provide flow communication from a first side of the second cap to a second side of the second cap opposite the first cap. The filter element may further include an outer tubular member extending between the first cap and the second cap, with the outer tubular member including a plurality of outer apertures. The filter element may also include an inner tubular member at least partially inside the outer tubular member. The filter element may also include filter media configured to promote separation of a first fluid from a second fluid having different characteristics than the first fluid as fluid passes through the filter media, wherein the filter media extends between the first cap and the second cap and around an exterior surface of the outer tubular member, such that space exists between an exterior surface of the filter media and an interior surface of the canister. The filter element may be configured such that fluid entering the filter element flows between an exterior surface of the inner tubular member and an interior surface of the outer tubular member, through at least some of the plurality of apertures in the outer tubular member, and through the filter media. The filter element may be configured such that a portion of the fluid may flow from the first side of the second cap to the second side of the second cap, but not into the inner tubular member. The filter assembly may further include a collection bowl coupled to the filter element and configured to receive the portion of the fluid flow that flows from the first side of the second cap to the second side of the second cap, but not into the inner tubular member.

According to another aspect, a method for separating a first fluid from a second fluid having different characteristics than the first fluid may include flowing a fluid including a first fluid and a second fluid from a filter base into a canister containing filter media configured to promote separation of the first fluid from the second fluid as the fluid passes through the filter media. The method may further include flowing the fluid through the filter media to separate at least a portion of the first fluid from the second fluid, and flowing the first fluid into a collection bowl configured to capture the first fluid. The method may further include flowing the second fluid via an inner tubular member out of the filter element and into the filter base.

According to another aspect, a filter element may include an outer tubular member having a longitudinal axis and extending between a first end and a second end. The outer tubular member may include a plurality of outer apertures. The filter element may further include an inner tubular member at least partially inside the outer tubular member, and a first cap coupled to the first end of the outer tubular member, with the first cap including a first inlet passage configured to provide flow communication into the filter element. The filter element may also include a second cap coupled to the second end of the outer tubular member, wherein the second cap is configured to provide flow communication from a first side of the second cap to a second side of the second cap opposite the first cap. The filter element may further include filter media configured to promote separation of a first fluid from a second fluid having different characteristics than the first fluid as fluid passes through the filter media. The filter media may extend between the first cap and the second cap and around an exterior surface of the outer tubular member. The first cap may be configured such that fluid entering the filter element flows between an exterior surface of the inner tubular member and an interior surface of the outer tubular member, through at least some of the plurality of apertures in the outer tubular member, and through the filter media. The filter element may be configured such that a portion of the fluid may flow from the first side of the second cap to the second side of the second cap, but not into the inner tubular member.

According to another aspect, a filter assembly may include a canister having a longitudinal axis and extending between a first end and a second end of the canister. The filter assembly may also include a filter element received in the canister. The filter element may include an outer tubular member having a longitudinal axis and extending between a first end and a second end, with the outer tubular member including a plurality of outer apertures. The filter element may also include an inner tubular member at least partially inside the outer tubular member, and a first cap coupled to the first end of the outer tubular member, with the first cap including a first inlet passage configured to provide flow communication into the filter element. The filter element may also include a second cap coupled to the second end of the outer tubular member, wherein the second cap is configured to provide flow communication from a first side of the second cap to a second side of the second cap opposite the first cap. The filter element may also include filter media configured to promote separation of a first fluid from a second fluid having different characteristics than the first fluid as fluid passes through the filter media. The filter media may extend between the first cap and the second cap and around an exterior surface of the outer tubular member. The first cap may be configured such that fluid entering the filter element flows between an exterior surface of the inner tubular member and an interior surface of the outer tubular member, through at least some of the plurality of apertures in the outer tubular member, and through the filter media. The filter element may be configured such that a portion of the fluid flows from the first side of the second cap to the second side of the second cap, but not into the inner tubular member. The filter assembly may further include a collection bowl coupled to the second end of the canister and configured to receive the portion of the fluid flow that flows from the first side of the second cap to the second side of the second cap but does not flow into the inner tubular member.

According to another aspect, a method for separating a first fluid from a second fluid having different characteristics than the first fluid may include flowing a fluid including a first fluid and a second fluid from a filter base into a filter element including filter media configured to promote separation of the first fluid from the second fluid as the fluid passes through the filter media. The method may further include flowing the fluid through the filter media to separate at least a portion of the first fluid from the second fluid, and flowing the first fluid into a collection bowl configured to capture the first fluid. The method may further include flowing the second fluid via an inner tubular member out of the filter element and into the filter base.

### BRIEF DESCRIPTION OF THE DRAWINGS

FIG. 1 is a perspective view of an exemplary embodiment of a filter assembly.

FIG. 2 is a side section view of the exemplary embodiment shown in FIG. 1.

FIG. 3 is a perspective section view of the exemplary embodiment shown in FIG. 1.

FIG. 4 is a perspective view of another exemplary embodiment of a filter assembly.

FIG. 5 is a side section view of the exemplary embodiment shown in FIG. 4.

FIG. 6 is a perspective section view of the exemplary embodiment shown in FIG. 4.

FIG. 7 is a perspective view of another exemplary embodiment of a filter assembly.

FIG. 8 is a side section view of the exemplary embodiment shown in FIG. 7.

FIG. 9 is a perspective section view of a portion of the exemplary embodiment shown in FIG. 7.

FIG. 10 is a perspective section view of another portion of the exemplary embodiment shown in FIG. 7.

FIG. 11 is an exploded perspective view of a portion of the exemplary embodiment shown in FIG. 7.

FIG. 12 is a perspective view of a portion of the exemplary embodiment shown in FIG. 7.

FIG. 13 is a partial perspective section view of a portion of the exemplary embodiment shown in FIG. 7.

FIG. 14 is a partial side section view of a portion of the exemplary embodiment shown in FIG. 7.

FIG. 15 is a partial perspective view of a portion of the exemplary embodiment shown in FIG. 7.

### DETAILED DESCRIPTION

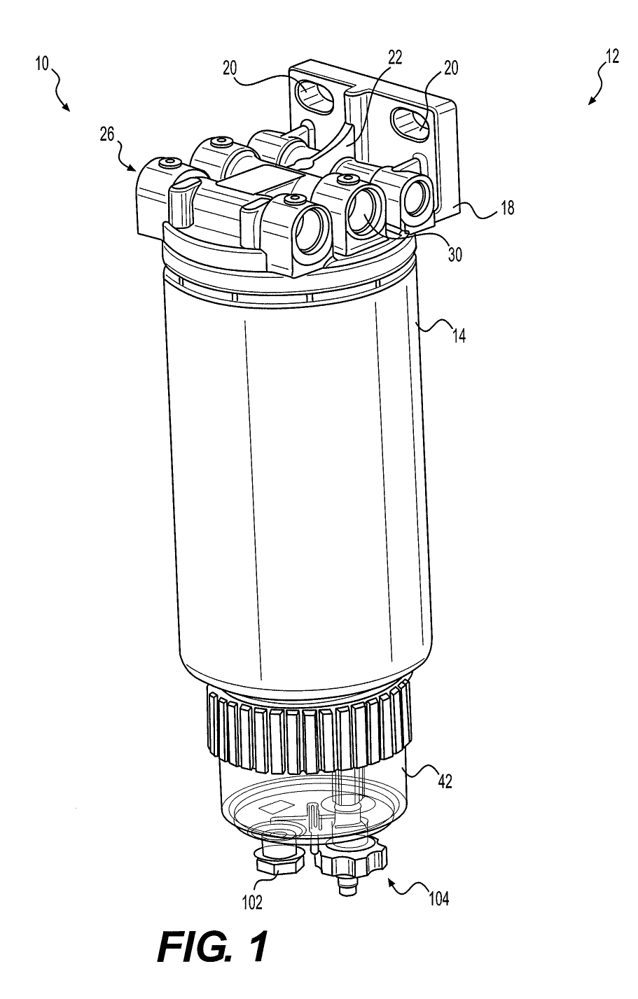

FIGS. 1-3 illustrate an exemplary embodiment of a filter assembly 10. Filter assembly 10 shown in FIGS. 1-3 may be used to filter fluids such as, for example, fuel, lubricants, coolants, and hydraulic fluid used by machines. According to some embodiments, filter assembly 10 may be used as a fuel/water separator filter, as explained in more detail below, and/or as an air filter. Other uses may be contemplated.

Exemplary filter assembly 10 shown in FIGS. 1-3 includes a filter base 12 configured to couple filter assembly 10 to a machine, a canister 14 configured to be coupled to filter base 12, and a filter element 16 configured to be received in canister 14. According to some embodiments, for example, the embodiment shown in FIGS. 1-3, canister 14 and filter element 16 may be formed as a single part, such that canister 14 is part of filter element 16. Such embodiments may be configured such that filter element 16 including canister 14 is coupled to filter base 12 in a “spin-on” fashion. According to some embodiments, canister 14 and filter element 16 are separate parts, with filter element 16 being configured to be received in a separate canister 14 and removed from canister 14 during servicing or replacement.

Exemplary filter base 12 includes a mounting bracket 18 having at least one hole 20 (e.g., two holes 20) for receiving a fastener for coupling filter base 12 to a machine. Other coupling configurations are contemplated. Exemplary filter base 12 also includes an extension 22 and a filter element sealing surface 24 configured to be coupled to filter element 16. Extension 22 serves to space filter element sealing surface 24 from mounting bracket 18 to provide clearance for canister 14. For example, filter element sealing surface 24 may include a filter base stud 25 configured to engage with a complimentary threaded portion of filter element 16.

As shown in FIGS. 1-3, exemplary filter element sealing surface 24 of filter base 12 includes an inlet passage 26, a receiver 28, and an outlet passage 30. Exemplary inlet passage 26 is configured to be coupled to a fluid conduit of a fluid system, such as, for example, a fuel system, a lubrication system, a hydraulic system, or a coolant system, such that it receives fluid for filtration in filter assembly 10. Exemplary receiver 28 is configured to receive a portion of filter element 16, as explained in more detail herein. Exemplary outlet passage 30 is configured to be coupled to a fluid conduit of the fluid system, such that fluid exiting filter assembly 10 returns to the fluid system following filtration.

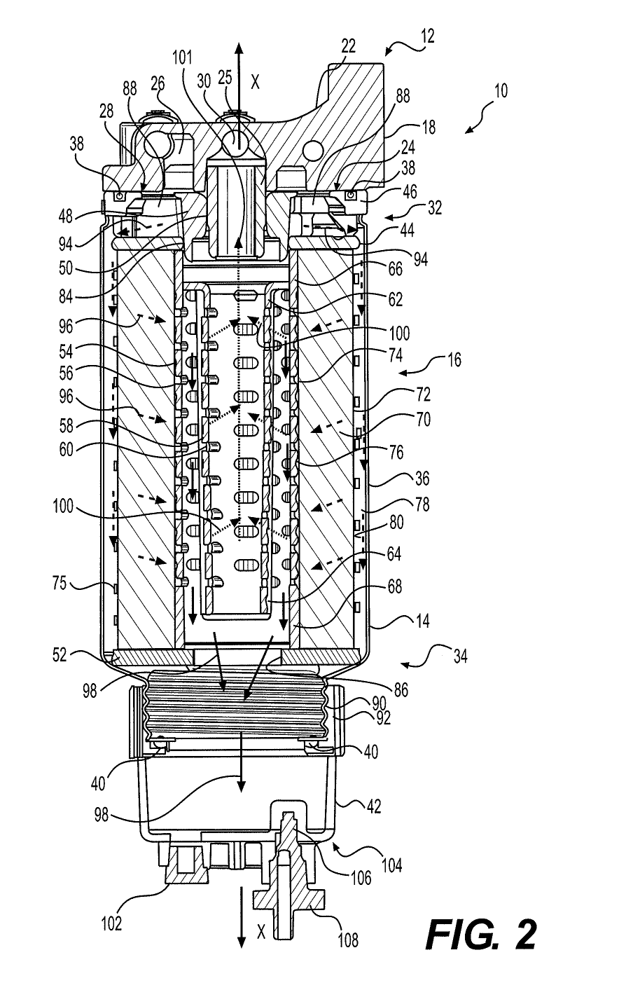

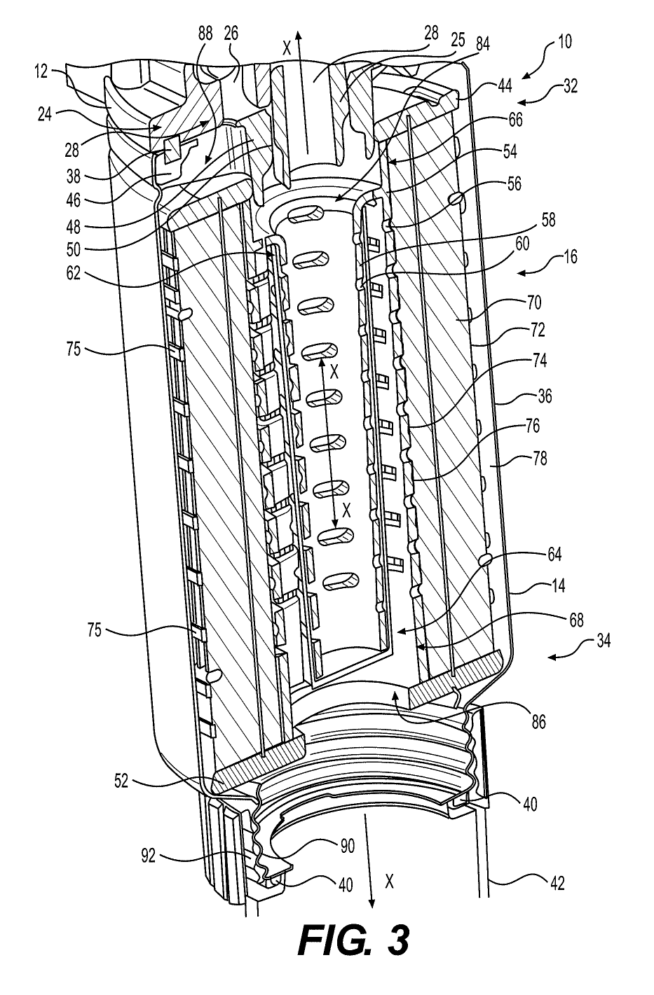

Exemplary canister 14 shown in FIG. 1 includes a longitudinal axis X, a first end 32, an oppositely-disposed second end 34, and a body portion 36 extending therebetween. As shown in FIGS. 2 and 3, first end 32 and second end 34 are open ends. Canister 14 includes also a seal member 38 (e.g., an annular o-ring seal) adjacent first end 32 and a seal member 40 (e.g., an annular o-ring seal) adjacent second end 34. Seal members 38 and 40 are configured to provide, respectively, a fluid-tight seal between first end 32 of canister 14 and filter base 12, and between second end 34 of canister 14 and a collection bowl 42 (e.g., a water collection bowl) coupled to second end 34 of canister 14. In the exemplary embodiment shown in FIGS. 1-3, seal member 38 is pressed against filter base 12 when filter element 16 is coupled to filter base 12 to provide a fluid-tight barrier between canister 14 and filter base 12. Similarly, seal member 40 is pressed against collection bowl 42 when filter element 16 is coupled to collection bowl 42 to provide a fluid-tight barrier between canister 14 and collection bowl 42.

Exemplary canister 14 may define a cross-section that is substantially circular, substantially oval-shaped, and/or substantially polygonal. According to some embodiments, the cross-sections may be substantially constant along the longitudinal length of canister 14. According to some embodiments, the cross-section may vary along the longitudinal length of canister 14. The cross-section may be chosen based on various considerations, such as, for example, the size and shape of the available space at a location of a machine that receives filter assembly 10.

As shown in FIGS. 2 and 3, exemplary filter element 16 includes a first cap 44 coupled to first end 32 of canister 14. For example, as shown in FIGS. 2 and 3, first cap 44 is coupled to a top plate 46, and top plate 46 is coupled to first end 32 of canister 14. Exemplary top plate 46 includes a sleeve 48 configured to be coupled to filter base 12. For example, exemplary sleeve 48 includes a threaded portion 50 (e.g., internally threaded) configured to engage filter base stud 25 of filter base 12, thereby coupling filter element 16 to filter base 12 in a “spin-on” fashion. Exemplary filter element 16 shown in FIGS. 1-3 also includes a second cap 52 coupled to filter element 16 (e.g., coupled at second end 34 of canister 14, either directly or indirectly).

In the exemplary embodiment shown in FIGS. 1-3, filter element 16 includes an outer tubular member 54 extending between first cap 44 and second cap 52, with outer tubular member 54 including a plurality of outer apertures 56. Filter element 16 also includes an inner tubular member 58 at least partially inside outer tubular member 54, with inner tubular member 58 including a plurality of inner apertures 60. For example, as shown in FIGS. 2 and 3, inner tubular member 58 has a longitudinal axis and extends between a first end 62 and a second end 64 (e.g., a closed end), and outer tubular member 54 has a longitudinal axis and extends between a first end 66 and a second end 68. The longitudinal axes of outer tubular member 54 and inner tubular member 58 are substantially parallel to (e.g., substantially co-linear with) longitudinal axis X of canister 14. In the exemplary embodiment shown, first end 62 of inner tubular member 58 is coupled to first end 66 of outer tubular member 54, and second end 64 of inner tubular member 58 is not coupled second end 68 of outer tubular member 54.

The exemplary embodiment shown in FIGS. 1-3 also includes filter media 70 configured to promote separation of a first fluid from a second fluid having different characteristics than the first fluid as fluid passes through filter media 70. For example, filter media 70 may be configured to promote separation of water from fuel as fuel including at least a small percentage of water passes through filter media 70. For example, filter media 70 may include a filtration substance that tends to coalesce water as the fluid containing water passes from one circumferential surface to another, for example, from an exterior surface 72 to an interior surface 74, or from interior surface 74 to exterior surface 72. According to some embodiments, filter media 70 may be configured to capture particulate matter in fluid enter filter element 16 from filter base 12. According to some embodiments, filter media 70 may include a roving 75 (e.g., spirally-wrapped) configured to secure filter media 70 against outer tubular member 54. Although the exemplary embodiment shown includes spirally-wound roving 75, alternative ways to couple filter media 70 to outer tubular member 54 are contemplated.

As shown in FIGS. 2 and 3, exemplary filter media 70 extends between first cap 44 and second cap 52 and around an exterior surface 76 of outer tubular member 54, such that a space 78 (e.g., an annular space) exists between exterior surface 72 of filter media 70 and an interior surface 80 of canister 14. In the exemplary embodiment shown in FIGS. 2 and 3, fluid entering filter element 16 flows between interior surface 80 of canister 14 and exterior surface 72 of filter media 70, and through filter media 70, such that a portion of the fluid flows into outer tubular member 54, but not into inner tubular member 58. As shown in FIG. 2, exemplary filter element 16 is configured such that a second portion of fluid flows into inner tubular member 58. For example, first cap 44 includes an outlet passage 84 in flow communication with inner tubular member 58, such that fluid flowing into inner tubular member 58 is in flow communication with outlet passage 84. Second cap 52 includes a second outlet passage 86 in flow communication with outer tubular member 54, such that the portion of fluid that flows into outer tubular member 54, but not into inner tubular member 58, is in flow communication with second outlet passage 86.

As shown in FIGS. 2 and 3, exemplary top plate 46 of filter element 16 is configured to direct fluid entering filter element 16 to flow between interior surface 80 of canister 14 and exterior surface 72 of filter media 70. For example, top plate 46 includes a plurality of inlet ports 88 providing flow communication with space 78.

As shown in FIGS. 2 and 3, second end 34 of canister 14 includes a threaded portion 90 configured to be coupled to a complimentary threaded portion 92 of collection bowl 42. Seal member 40 is pressed against collection bowl 42 when canister 14 is coupled to collection bowl 42 to provide a fluid-tight barrier between canister 14 and collection bowl 42.

As shown in FIGS. 2 and 3, exemplary filter assembly 10 and filter element 16 may be configured to remove at least a portion of water (and particulates) from fuel passing through filter element 16. For example, fluid for filtration enters filter element 16 via inlet passage 26 of filter base 12, flowing through one or more inlet ports 88 of top plate 46 (see arrow 94). Inlet ports 88 are configured to direct fluid into space 78 between exterior surface 72 of filter media 70 and interior surface 80 of canister 14. Second cap 52 is coupled to second end 34 of canister 14, such that fluid in space 78 is forced to pass from exterior surface 72 of filter media 70 to interior surface 74 of filter media 70 (see arrows 96), which promotes separation of water from fuel in the fluid (e.g., it coalesces the water as is passes through filter media 70). The water and fuel pass through outer apertures 56 and thereby enter outer tubular member 54. The water, at least partially coalesced into water droplets, drops down outer tubular member 54 and through second outlet passage 86 of second cap 52, where it collects in collection bowl 42 (see arrows 98). Fuel separated from the water thereafter passes into inner tubular member 58 via inner apertures 60 (see arrows 100), either directly, or after collecting atop water in collection bowl 42 as a result of the fuel not remixing with the water and having a lower density than the water. Thereafter, fuel inside inner tubular member 58 travels (under pressure) up through inner tubular member 58 to outlet passage 84 and into outlet passage 30 of base element (see arrow 101), where the filtered fuel returns to a fuel system.

According to some embodiments, for example, as shown in FIGS. 2 and 3, filter element 16 is configured such that the portion of the fluid that flows into outer tubular member 54, but not into inner tubular member 58 (e.g., water) flows between inner tubular member 58 and outer tubular member 54 in a direction substantially parallel to longitudinal axis X of canister 14 and toward second cap 52. As shown, exemplary filter element 16 is also configured, such that a second portion of the fluid flows into inner tubular member 58 (e.g., fuel), and the second portion flows in a direction substantially parallel to longitudinal axis X of canister 14 and toward first cap 44. Thus, the portion of the fluid that flows into outer tubular member 54, but not into inner tubular member 58, and the second portion that flows into inner tubular member 58 flow in substantially opposite directions, which may further promote the separation of the two portions of fluid (e.g., the water from the fuel).

According to some embodiments, a method for separating a first fluid from a second fluid having different characteristics than the first fluid (e.g., separating water from fuel) may include flowing a fluid including a first fluid and a second fluid from filter base 12 into canister 14 (see, e.g., arrow 94) containing filter media 70 configured to promote separation of the first fluid from the second fluid as the fluid passes through filter media 70. The method may further include flowing the fluid through filter media 70 (see, e.g., arrows 96) to separate at least a portion of the first fluid from the second fluid, and flowing the first fluid via outer tubular member 54 into collection bowl 42 (see, e.g., arrows 98) configured to capture the first fluid. The method according to some embodiments may also include flowing the second fluid via inner tubular member 58 out of filter element 16 and into filter base 12 (see, e.g., arrow 101). According to some embodiments, flowing the first fluid into collection bowl 42 includes flowing the first fluid in a first direction substantially parallel to longitudinal axis X of canister 14, and flowing the second fluid out of filter element 14 includes flowing the second fluid in a second direction substantially parallel to longitudinal axis X and opposite to the first direction. According to some embodiments, flowing the fluid through filter media 70 includes flowing the fluid in a direction transverse to the first direction and the second direction (e.g., see arrows 96). For example, the exemplary embodiment of filter assembly 10 shown in FIGS. 1-3 could be used to perform these exemplary methods.

According to some embodiments, at least portions of collection bowl 42 may be configured such that it is possible to determine the level of the fluid in collection bowl 42. For example, at least a portion of collection bowl 42 (e.g., all of collection bowl 42) may be clear or translucent so that it is possible to determine the level of water in collection bowl 42. This may permit an operator or service technician to determine whether it might be advisable to remove the fluid from collection bowl 42. This may substantially prevent enough water from accumulating in collection bowl 42 to be carried up into inner tubular member 58, through outlet passage 84 of first cap 44 and outlet passage 30 of filter base 12, and into the fuel system downstream of filter assembly 10. According to some embodiments, a sensor 102 may be provided to sense whether water should be removed from collection bowl 42. Sensor 102 may be replaced with a plug. According to some embodiments, sensor 102 may rely on various differences between water and fuel to determine whether water should be removed from collection bowl 42. As shown in FIGS. 1 and 2, some embodiments of filter assembly 10 may include a drain 104 including a drain hole 106 and a drain plug 108 configured to facilitate removal of fluid (e.g., water) from collection bowl 42.

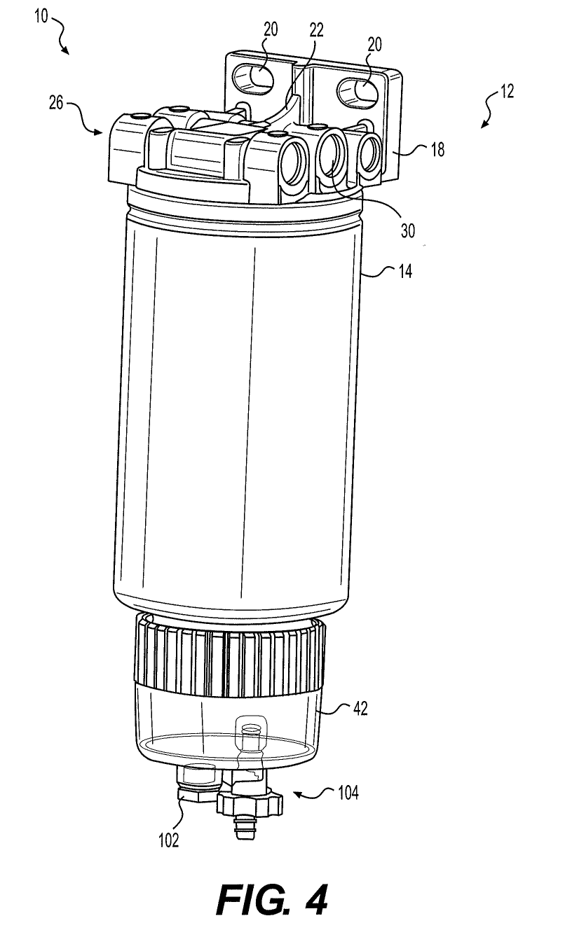

FIGS. 4-6 show an alternative embodiment of filter assembly 10 that may provide improved separation of a first fluid from a second fluid having different characteristics than the first fluid (e.g., separating water from fuel). The exemplary embodiment of filter assembly 10 shown in FIGS. 4-6 is configured to provide a different flow path as compared to the exemplary embodiment of filter assembly 10 shown in FIGS. 1-3. The exemplary embodiment shown in FIGS. 4-6 may include additional differences, as explained below.

Exemplary filter assembly 10 shown in FIGS. 4-6 includes a filter base 12 configured to couple filter assembly 10 to a machine, a canister 14 configured to be coupled to filter base 12, and a filter element 16 configured to be received in canister 14. According to some embodiments, for example, the embodiment shown in FIGS. 4-6, canister 14 and filter element 16 may be formed as a single part, such that canister 14 is part of filter element 16. Such embodiments may be configured such that filter element 16, including canister 14, is coupled to filter base 12 in a “spin-on” fashion. According to some embodiments, canister 14 and filter element 16 are separate parts, with filter element 16 being configured to be received in canister 14 and removed from canister 14 during servicing or replacement.

Exemplary filter base 12 includes a mounting bracket 18 having at least one hole 20 (e.g., two holes 20) for receiving a fastener for coupling filter base 12 to a machine. Other coupling configurations are contemplated. Exemplary filter base 12 also includes an extension 22 and a filter element sealing surface 24 configured to be coupled to filter element 16. Extension 22 serves to space filter element sealing surface 24 from mounting bracket 18 to provide clearance for canister 14. For example, filter element sealing surface 24 may include a filter base stud 25 configured to engage with a complimentary threaded portion of filter element 16.

As shown in FIGS. 4-6, exemplary filter element sealing surface 24 of filter base 12 includes an inlet passage 26, a receiver 28, and an outlet passage 30. Exemplary inlet passage 26 is configured to be coupled to a fluid conduit of a fluid system, such as, for example, a fuel system, a lubrication system, a hydraulic system, or a coolant system, such that it receives fluid for filtration in filter assembly 10. Exemplary receiver 28 is configured to receive a portion of filter element 16, as explained in more detail herein. Exemplary outlet passage 30 is configured to be coupled to a fluid conduit of the fluid system, such that fluid exiting filter assembly 10 returns to the fluid system following filtration.

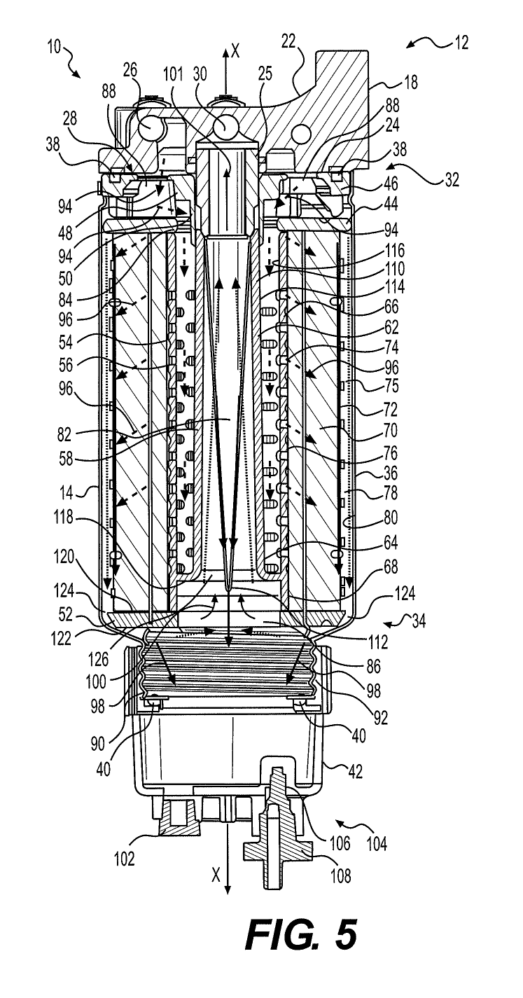

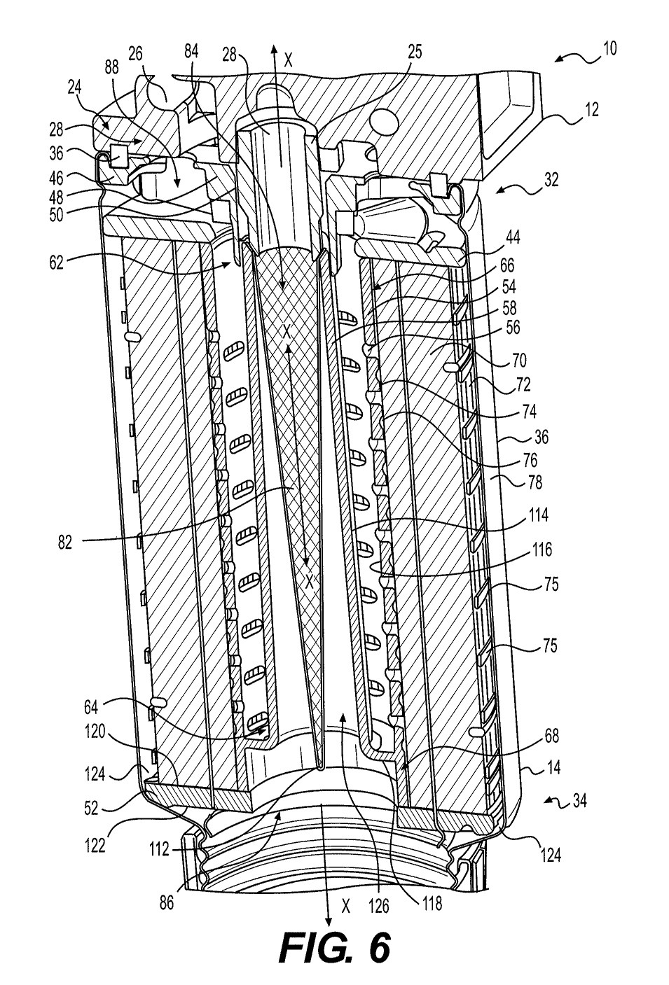

Exemplary canister 14 shown in FIG. 4 includes a longitudinal axis X, a first end 32, an oppositely-disposed second end 34, and a body portion 36 extending therebetween. As shown in FIGS. 5 and 6, first end 32 and second end 34 are open ends. Canister 14 includes also a seal member 38 (e.g., an annular o-ring seal) adjacent first end 32 and a seal member 40 (e.g., an annular o-ring seal) adjacent second end 34. Seal members 38 and 40 are configured to provide, respectively, a fluid-tight seal between first end 32 of canister 14 and filter base 12, and between second end 34 of canister 14 and a collection bowl 42 (e.g., a water collection bowl) coupled to second end 34 of canister 14. In the exemplary embodiment shown in FIGS. 4-6, seal member 38 is pressed against filter base 12 when filter element 16 is coupled to filter base 12 to provide a fluid-tight barrier between canister 14 and filter base 12. Similarly, seal member 40 is pressed against collection bowl 42 when filter element 16 is coupled to collection bowl 42 to provide a fluid-tight barrier between canister 14 and collection bowl 42.

Exemplary canister 14 may define a cross-section that is substantially circular, substantially oval-shaped, and/or substantially polygonal. According to some embodiments, the cross-sections may be substantially constant along the longitudinal length of canister 14. According to some embodiments, the cross-section may vary along the longitudinal length of canister 14. The cross-section may be chosen based on various considerations, such as, for example, the size and shape of the available space at a location of a machine that receives filter assembly 10.

As shown in FIGS. 5 and 6, exemplary filter element 16 includes a first cap 44 coupled to first end 32 of canister 14. For example, as shown in FIGS. 5 and 6, first cap 44 is coupled to a top plate 46, and top plate 46 is coupled to first end 32 of canister 14. Exemplary top plate 46 includes a sleeve 48 configured to be coupled to filter base 12. For example, exemplary sleeve 48 includes a threaded portion 50 (e.g., internally threaded) configured to engage filter base stud 25 of filter base 12, thereby coupling filter element 16 to filter base 12 in a “spin-on” fashion. Exemplary filter element 16 shown in FIGS. 4-6 also includes a second cap 52 coupled to filter element 16 (e.g., coupled at second end 34 of canister 14, either directly or indirectly).

In the exemplary embodiment shown in FIGS. 4-6, filter element 16 includes an outer tubular member 54 extending between first cap 44 and second cap 52, with outer tubular member 54 including a plurality of outer apertures 56. Filter element 16 also includes an inner tubular member 58 at least partially inside outer tubular member 54. Unlike outer tubular member 54, inner tubular member 58 shown in FIGS. 5 and 6 does not include any apertures. For example, inner tubular member 58 includes a tubular wall 110 extending in a direction substantially parallel to longitudinal axis X of canister 14, and tubular wall 110 does not include any apertures. As shown in FIGS. 5 and 6, inner tubular member 58 has a longitudinal axis and extends between a first end 62 and a second end 64, and outer tubular member 54 has a longitudinal axis and extends between a first end 66 and a second end 68. The longitudinal axes of outer tubular member 54 and inner tubular member 58 are substantially parallel to (e.g., substantially co-linear with) longitudinal axis X of canister 14. In the exemplary embodiment shown, second end 64 of inner tubular member 58 is coupled to second end 68 of outer tubular member 54, and first end 62 of inner tubular member 58 is not coupled directly to first end 66 of outer tubular member 54.

The exemplary embodiment shown in FIGS. 4-6 also includes filter media 70 configured to promote separation of a first fluid from a second fluid having different characteristics than the first fluid as fluid passes through filter media 70. For example, filter media 70 may be configured to promote separation of water from fuel as fuel including at least a small percentage of water passes through filter media 70. For example, filter media 70 may include a filtration substance that tends to coalesce water as the fluid containing water passes from one circumferential surface to another, for example, from an interior surface 74 to an exterior surface 72. According to some embodiments, filter media 70 may be configured to capture particulate matter in fluid enter filter element 16 from filter base 12. According to some embodiments, filter media 70 may include a roving 75 (e.g., spirally-wrapped) configured to secure filter media 70 against outer tubular member 54. Although the exemplary embodiment shown includes spirally-wound roving 75, alternative ways to couple filter media 70 to outer tubular member 54 are contemplated.

According to some embodiments, filter element 16 may include a mesh member 82, for example, as shown in FIGS. 5 and 6, configured to promote additional separation of a first fluid from a second fluid having different characteristics than the first fluid as fluid passes through mesh member 82. For example, mesh member 82 may be configured to be hydrophobic, thereby tending to separate water from another fluid, such as, for example, fuel. As shown in FIGS. 5 and 6, exemplary mesh member 82 is substantially conical in configuration, with an apex 112 at second end 64 of inner tubular member 58 and extending from apex 112 toward first end 62 of inner tubular member 58.

As shown in FIGS. 5 and 6, exemplary filter media 70 extends between first cap 44 and second cap 52 and around an exterior surface 76 of outer tubular member 54, such that a space 78 (e.g., an annular space) exists between exterior surface 72 of filter media 70 and an interior surface 80 of canister 14. In the exemplary embodiment shown in FIGS. 5 and 6, fluid entering filter element 16 flows between an exterior surface 114 of inner tubular member and an interior surface 116 of outer tubular member 54. In the exemplary embodiment shown, inner tubular member 58 is coupled to outer tubular member 54 by a flange 118, and the absence of apertures in tubular wall 110 of inner tubular member 58 forces the fluid through outer apertures 56 of outer tubular member 54 and through filter media 70 from interior surface 74 of filter media 70 to exterior surface 72 of filter media 70. The fluid thereafter enters space 78 between interior surface 80 of canister 14 and exterior surface 72 of filter media 70.

In the exemplary embodiment shown in FIGS. 4-6, canister 14 and second cap 52 are configured such that fluid entering space 78 flows from a first side 120 of second cap 52 to a second side 122 of second cap 52 opposite first cap 44. For example, second cap 52 may provide passages 124 providing flow communication between first side 120 and second side 122 of second cap 52. As the fluid flows through filter media 70, a portion of the fluid may tend to coalesce and become separated from the rest of the fluid (e.g., water may tend to coalesce and become separated from fuel). The portion separated from the remainder of the fluid may flow past second cap 52 via passages 124 and collect in collection bowl 42, and the remainder or second portion of the fluid may flow through passages 124 and back into inner tubular member 58 via an inlet passage 126. As shown in FIG. 5, first cap 44 includes an outlet passage 84 in flow communication with inner tubular member 58, such that fluid flowing into inner tubular member 58 is in flow communication with outlet passage 84. As a result, a portion of the fluid flows from first side 120 of second cap 52 to second side 122 of second cap 52, but does not flow into inner tubular member 58 via inlet passage 126. Rather, this portion of fluid flows into collection bowl 42 for collection. As second portion of the fluid flows into inner tubular member 58, through mesh member 82, through outlet passage 84 of first cap 44, through sleeve 48 and outlet passage 30 of filter base 12, and back into the fuel system.

As shown in FIGS. 5 and 6, second end 34 of canister 14 includes a threaded portion 90 configured to be coupled to a complimentary threaded portion 92 of collection bowl 42. Seal member 40 is pressed against collection bowl 42 when canister 14 is coupled to collection bowl 42 to provide a fluid-tight barrier between canister 14 and collection bowl 42.

As shown in FIGS. 5 and 6, exemplary filter assembly 10 and filter element 16 may be configured to remove at least a portion of water (and particulates) from fuel passing through filter element 16. For example, fluid for filtration enters filter element 16 via inlet passage 26 of filter base 12, flowing through one or more inlet ports 88 of top plate 46 (see arrows 94). Inlet ports 88 are configured to direct fluid between interior surface 116 of outer tubular member 54 and exterior surface 114 of inner tubular member 58. Second end 64 of inner tubular member 58 is coupled to second end 68 of outer tubular member 54, such that the fluid is forced to pass through outer apertures 56, and from interior surface 74 of filter media 70 to exterior surface 72 of filter media 70 (see arrows 96), which promotes separation of water from fuel in the fluid (e.g., it coalesces the water as is passes through filter media 70). The water and fuel thereby enter space 78. The water, at least partially coalesced into water droplets, drops down space 78 and through passages 124 of second cap 52, where it collects in collection bowl 42 (see arrows 98). Fuel separated from the water also passes through passages 124, but into inner tubular member 58 via inlet passage 126 (see arrow 100), either directly or after collecting atop water in collection bowl 42 as a result of the fuel not remixing with the water and having a lower density than the water. Thereafter, fuel inside inner tubular member 58 travels (under pressure) up through inner tubular member 58 through mesh member 82 to outlet passage 84, and into outlet passage 30 of filter base 12 (see arrow 101), where the filtered fuel returns to a fuel system.

According to some embodiments, for example, as shown in FIGS. 5 and 6, filter element 16 is configured such that the portion of the fluid that flows from first side 120 of second cap 52 to second side 122 of second cap 52, but not into inner tubular member 58 (e.g., water), flows between inner tubular member 58 and outer tubular member 54 in a direction substantially parallel to longitudinal axis X of canister 14 and away from first cap 44. As shown, exemplary filter element 16 is also configured such that a second portion of the fluid flows into inner tubular member 58 (e.g., fuel), and the second portion flows in a direction substantially parallel to longitudinal axis X of canister 14 and toward first cap 44. Thus, the portion of the fluid that flows from first side 120 of second cap 52 to second side 122 of second cap 52, but not into inner tubular member 58, and the second portion that flows into inner tubular member 58, flow in substantially opposite directions, which may further promote the separation of the two portions of fluid (e.g., the water from the fuel).

According to some embodiments, a method for separating a first fluid from a second fluid having different characteristics than the first fluid (e.g., separating water from fuel) may include flowing a fluid including a first fluid and a second fluid from filter base 12 into canister 14 (see, e.g., arrow 94) containing filter media 70 configured to promote separation of the first fluid from the second fluid as the fluid passes through filter media 70. The method may further include flowing the fluid through filter media 70 (see, e.g., arrows 96) to separate at least a portion of the first fluid from the second fluid, and flowing the first fluid into collection bowl 42 (see, e.g., arrows 98) configured to capture the first fluid. The method according to some embodiments may also include flowing the second fluid via inner tubular member 58 out of filter element 16 and into filter base 12 (see, e.g., arrow 101). According to some embodiments, flowing the first fluid into collection bowl 42 includes flowing the first fluid in a first direction substantially parallel to longitudinal axis X of canister 14, and flowing the second fluid out of filter element 14 includes flowing the second fluid in a second direction substantially parallel to longitudinal axis X and opposite to the first direction. According to some embodiments, flowing the fluid through filter media 70 includes flowing the fluid in a direction transverse to the first direction and the second direction (e.g., see arrows 96). For example, the exemplary embodiment of filter assembly 10 shown in FIGS. 4-6 could be used to perform these exemplary methods.

As shown in FIGS. 5 and 6, at least portions of collection bowl 42 may be configured such that it is possible to determine the level of the fluid in collection bowl 42. For example, at least a portion of collection bowl 42 (e.g., all of collection bowl 42) may be clear or translucent so that it is possible to determine the level of water in collection bowl 42. This may permit an operator or service technician to determine whether it might be advisable to remove the fluid from collection bowl 42. This may substantially prevent enough water from accumulating in collection bowl 42 to be carried up into inner tubular member 58, through outlet passage 84 of first cap 44 and outlet passage 30 of filter base 12, and into the fuel system downstream of filter assembly 10. According to some embodiments, a sensor 102 may be provided to sense whether water should be removed from collection bowl 42. Sensor 102 may be replaced with a plug. As shown in FIGS. 4 and 5, some embodiments of filter assembly 10 may include a drain 104 including a drain hole 106 and a drain plug 108 configured to facilitate removal of fluid (e.g., water) from collection bowl 42.

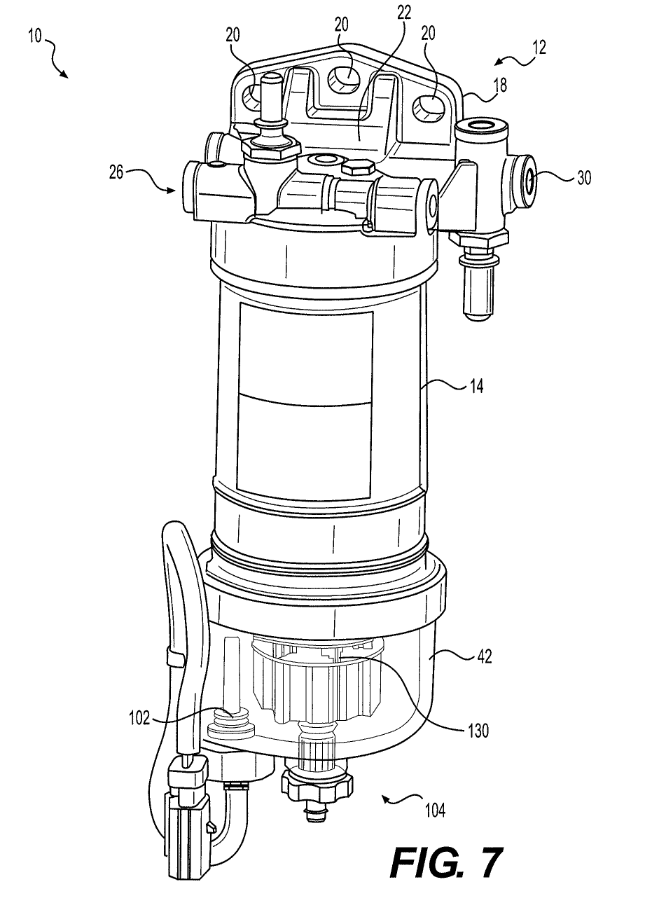

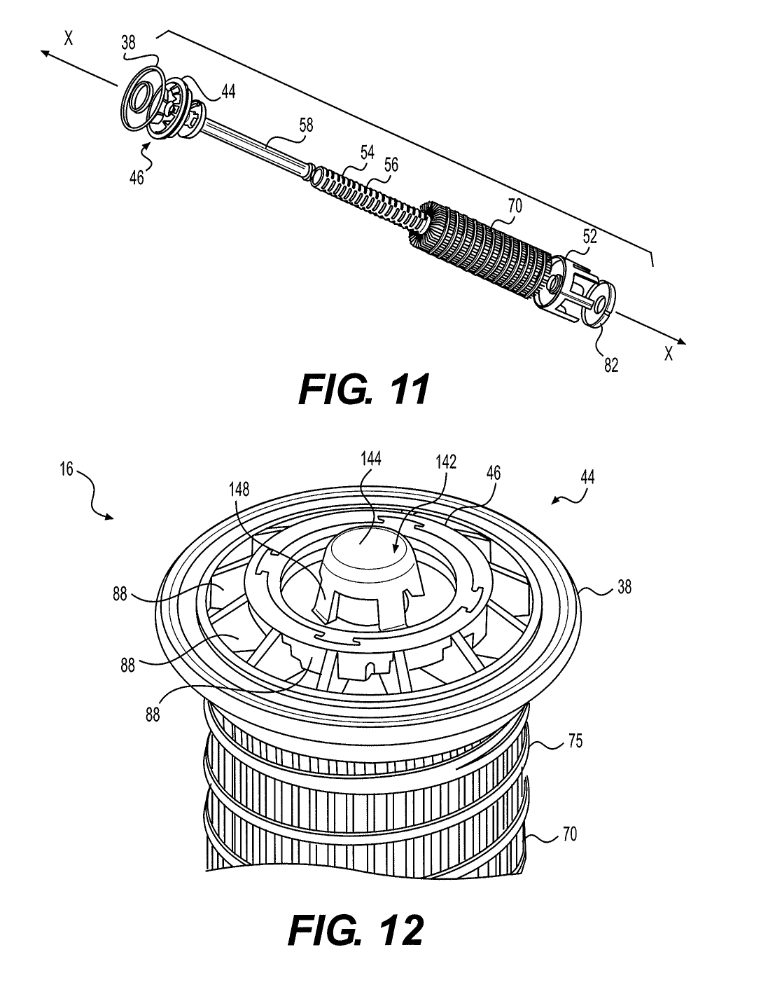

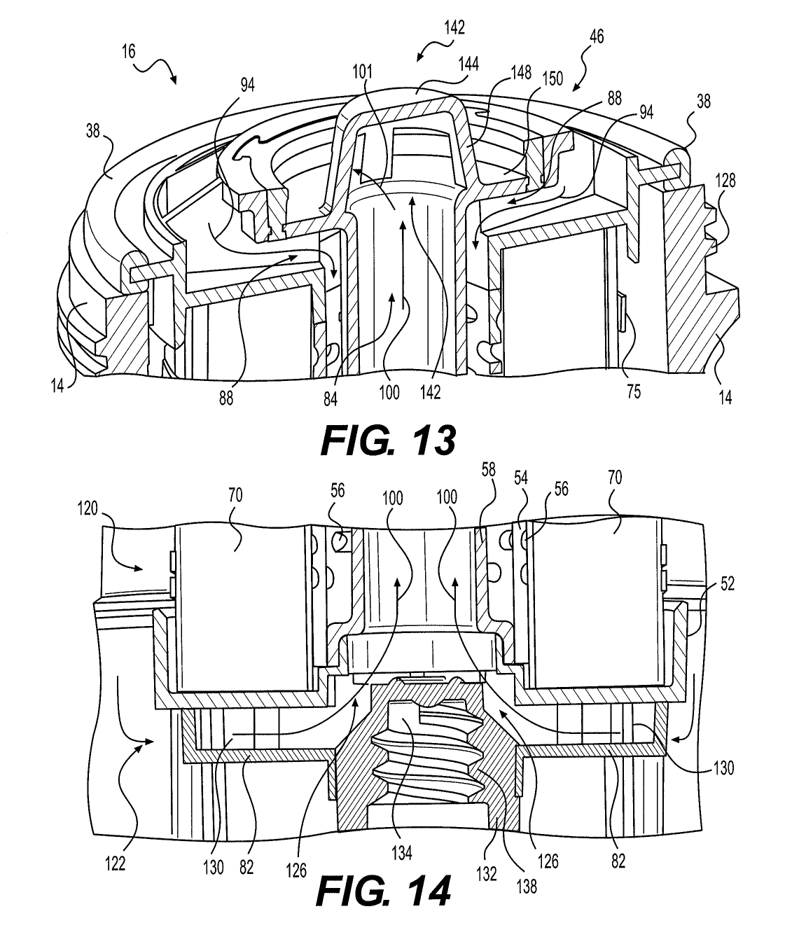

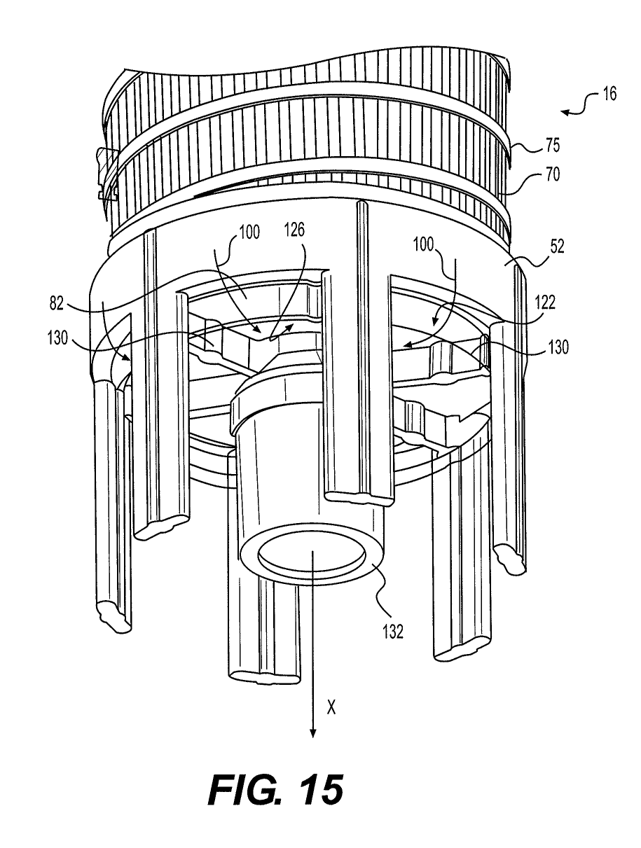

FIGS. 7-15 show an alternative embodiment of filter assembly 10 that may provide improved separation of a first fluid from a second fluid having different characteristics than the first fluid (e.g., separating water from fuel). The exemplary embodiment of filter assembly 10 shown in FIGS. 7-15 is configured to provide a different flow path as compared to the exemplary embodiment of filter assembly 10 shown in FIGS. 1-3, but a similar flow path to the exemplary embodiment shown in FIGS. 4-6. The exemplary embodiment shown in FIGS. 7-15 may include additional differences (and similarities), as explained below.

Exemplary filter assembly 10 shown in FIGS. 7-15 includes a filter base 12 configured to couple filter assembly 10 to a machine, a canister 14 configured to be coupled to filter base 12, and a filter element 16 configured to be received in canister 14. According to some embodiments, for example, the embodiment shown in FIGS. 7-15, canister 14 and filter element 16 are not formed as a single part. Rather, canister 14 and filter element 16 are separate parts, and filter element 16 is configured to be selectively insertable into and removable from canister 14 in a “drop-in” or cartridge fashion during servicing and/or replacement.

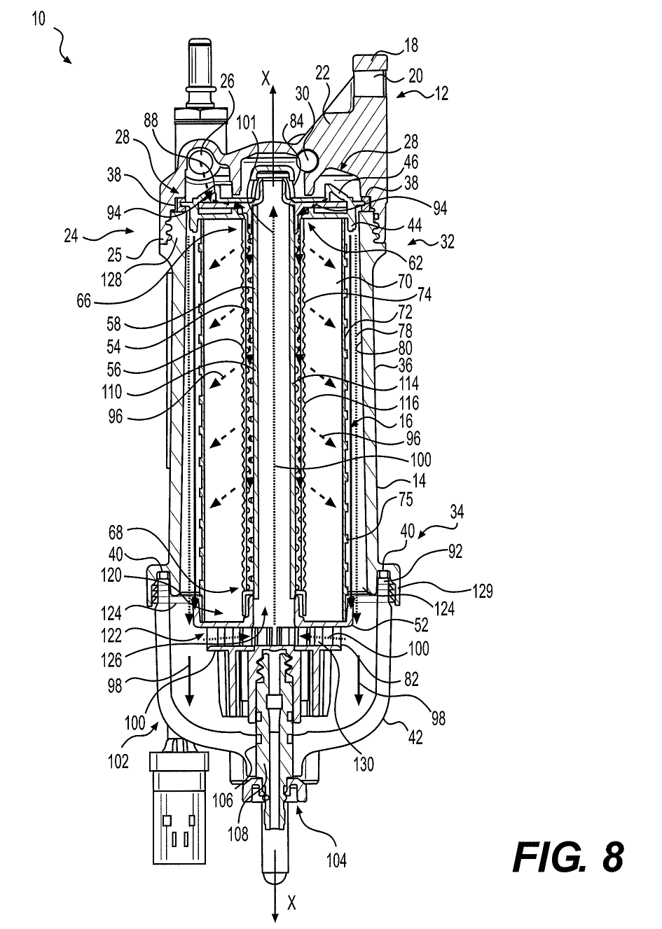

Exemplary filter base 12 includes a mounting bracket 18 having at least one hole 20 (e.g., three holes 20) for receiving a fastener for coupling filter base 12 to a machine. Other coupling configurations are contemplated. Exemplary filter base 12 also includes an extension 22 and a filter element sealing surface 24 configured to be coupled to filter element 16. Extension 22 serves to space filter element sealing surface 24 from mounting bracket 18 to provide clearance for canister 14. For example, filter element sealing surface 24 may include a filter base stud 25 configured to engage with a complimentary threaded portion 128 of canister 14, for example, as shown in FIG. 8.

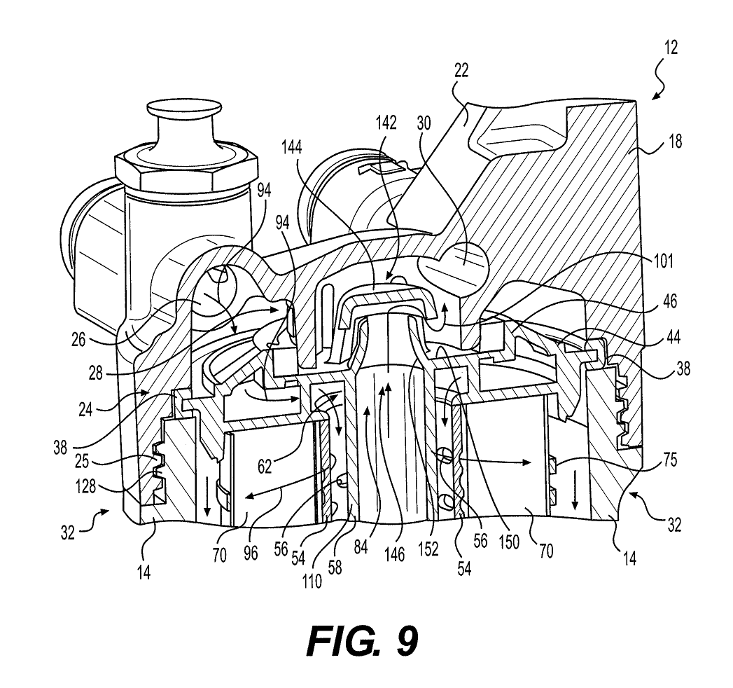

As shown in FIGS. 8 and 9, exemplary filter element sealing surface 24 of filter base 12 includes an inlet passage 26, a receiver 28, and an outlet passage 30. Exemplary inlet passage 26 is configured to be coupled to a fluid conduit of a fluid system, such as, for example, a fuel system, a lubrication system, a hydraulic system, or a coolant system, such that it receives fluid for filtration in filter assembly 10. Exemplary receiver 28 is configured to receive a portion of filter element 16. Exemplary outlet passage 30 is configured to be coupled to a fluid conduit of the fluid system, such that fluid exiting filter assembly 10 returns to the fluid system following filtration.

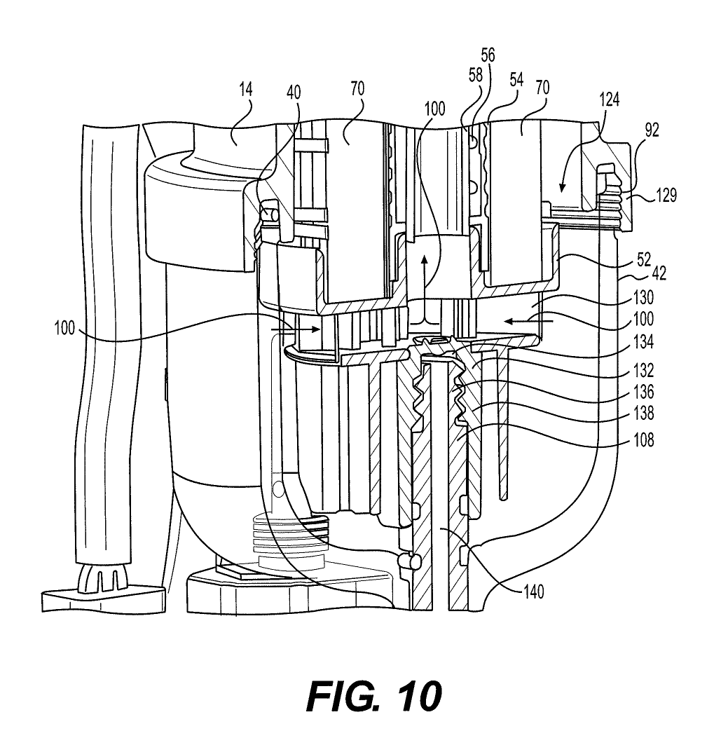

Exemplary canister 14 shown in FIG. 8 includes a longitudinal axis X, a first end 32, an oppositely-disposed second end 34, and a body portion 36 extending therebetween. As shown in FIG. 8, first end 32 and second end 34 are open ends. Filter element 16 includes a seal member 38 (e.g., an annular o-ring seal) adjacent first end 32 of canister (when assembled) and a seal member 40 (e.g., an annular o-ring seal) adjacent second end 34 of canister (see FIG. 10). Seal members 38 and 40 are configured to provide, respectively, a fluid-tight seal between first end 32 of canister 14 and filter base 12, and between second end 34 of canister 14 and a collection bowl 42 (e.g., a water collection bowl) coupled to second end 34 of canister 14. In the exemplary embodiment shown in FIGS. 7-15, seal member 38 is pressed against filter base 12 when filter element 16 is coupled to filter base 12 via canister 14 to provide a fluid-tight barrier between canister 14 and filter base 12. Similarly, seal member 40 is pressed against collection bowl 42 when filter element 16 is coupled to collection bowl 42 via canister 14 to provide a fluid-tight barrier between canister 14 and collection bowl 42.

Exemplary canister 14 may define a cross-section that is substantially circular, substantially oval-shaped, and/or substantially polygonal. According to some embodiments, the cross-sections may be substantially constant along the longitudinal length of canister 14. According to some embodiments, the cross-section may vary along the longitudinal length of canister 14. The cross-section may be chosen based on various considerations, such as, for example, the size and shape of the available space at a location of a machine that receives filter assembly 10.

As shown in FIGS. 7-15, exemplary filter element 16 includes a first cap 44 coupled to first end 32 of filter element 16. For example, as shown in FIGS. 8, 9, and 11-13, first cap 44 is in the form of a top plate 46, and top plate 46 is coupled to a first end 62 of an inner tubular member 58. Exemplary filter element 16 shown in FIGS. 7-15 also includes a second cap 52 coupled to filter element 16 (e.g., coupled at a second end 64 of inner tubular member 58, either directly or indirectly).

In the exemplary embodiment shown in FIGS. 7-15, filter element 16 includes an outer tubular member 54 extending between first cap 44 and second cap 52, with outer tubular member 54 including a plurality of outer apertures 56. Inner tubular member 58 is at least partially inside outer tubular member 54. Unlike outer tubular member 54, inner tubular member 58 shown in FIG. 8 does not include any apertures. For example, inner tubular member 58 includes a tubular wall 110 extending in a direction substantially parallel to longitudinal axis X of canister 14, and tubular wall 110 does not include any apertures. As shown in FIGS. 8 and 9, inner tubular member 58 has a longitudinal axis and extends between first end 62 and second end 64, and outer tubular member 54 has a longitudinal axis and extends between a first end 66 and a second end 68. The longitudinal axes of outer tubular member 54 and inner tubular member 58 are substantially parallel to (e.g., substantially co-linear with) longitudinal axis X of canister 14. In the exemplary embodiment shown, second end 64 of inner tubular member 58 is coupled to second end 68 of outer tubular member 54, and first end 62 of inner tubular member 58 is not coupled directly to first end 66 of outer tubular member 54.

The exemplary embodiment shown in FIGS. 7-15 also includes filter media 70 configured to promote separation of a first fluid from a second fluid having different characteristics than the first fluid as fluid passes through filter media 70. For example, filter media 70 may be configured to promote separation of water from fuel as fuel including at least a small percentage of water passes through filter media 70. For example, filter media 70 may include a filtration substance that tends to coalesce water as the fluid containing water passes from one circumferential surface to another, for example, from an interior surface 74 to an exterior surface 72. According to some embodiments, filter media 70 may be configured to capture particulate matter in fluid enter filter element 16 from filter base 12. According to some embodiments, filter media 70 may include a roving 75 (e.g., spirally-wrapped) configured to secure filter media 70 against outer tubular member 54. Although the exemplary embodiment shown includes spirally-wound roving 75, alternative ways to couple filter media 70 to outer tubular member 54 are contemplated.

As shown in FIG. 8, exemplary filter media 70 extends between first cap 44 and second cap 52 and around an exterior surface 76 of outer tubular member 54, such that a space 78 (e.g., an annular space) exists between exterior surface 72 of filter media 70 and an interior surface 80 of canister 14 when filter element 16 is received in canister 14. In the exemplary embodiment shown in FIG. 8, fluid entering filter element 16 flows between an exterior surface 114 of inner tubular member 58 and an interior surface 116 of outer tubular member 54. In the exemplary embodiment shown, inner tubular member 58 is coupled to outer tubular member 54 by a flange 118 (see FIG. 10), and the absence of apertures in tubular wall 110 of inner tubular member 58 forces the fluid through outer apertures 56 of outer tubular member 54 and through filter media 70 from interior surface 74 of filter media 70 to exterior surface 72 of filter media 70. The fluid thereafter enters space 78 between interior surface 80 of canister 14 and exterior surface 72 of filter media 70. In the exemplary embodiment shown in FIGS. 7-15, canister 14 and second cap 52 are configured such that fluid entering space 78 flows from a first side 120 of second cap 52 to a second side 122 of second cap 52 opposite first cap 44. For example, a gap between second cap 52 and canister 14 may provide one or more passages 124 providing flow communication between first side 120 and second side 122 of second cap 52. As the fluid flows through filter media 70, a portion of the fluid may tend to coalesce and become separated from the rest of the fluid (e.g., water may tend to coalesce and become separated from fuel). The portion separated from the remainder of the fluid may flow past second cap 52 via one or more passages 124 and collect in collection bowl 42, and the remainder or second portion of the fluid may flow through one or more passages 124 and back into inner tubular member 58 via an inlet passage 126. As shown in, for example, FIGS. 8, 9, and 13, first cap 44 includes an outlet passage 84 in flow communication with inner tubular member 58, such that fluid flowing into inner tubular member 58 is in flow communication with outlet passage 84. As a result of this exemplary configuration, a portion of the fluid flows from first side 120 of second cap 52 to second side 122 of second cap 52, but does not flow into inner tubular member 58 via inlet passage 126. Rather, this portion of fluid flows into collection bowl 42 for collection. A second portion of the fluid flows into inner tubular member 58, through outlet passage 84 of first cap 44, through outlet passage 30 of filter base, and back into the fuel system.

According to the exemplary embodiment shown in FIGS. 7-15, second cap 52 includes a plurality of legs 130 extending from second side 122 second cap 52 (e.g., opposite filter media 70) (see FIGS. 8, 10, 14, and 15). Fluid entering inlet passages 126 of inner tubular member 58 passes between legs 130, for example, as shown in FIGS. 8, 14, and 15. According to some embodiments, a mesh member 82 at least partially covers legs 130, such that fluid flowing from second side 122 of second cap 52 to inlet passage 126 passes through mesh member 82, for example, as shown in FIGS. 8, 10, 14, and 15. Mesh member 82 is configured to promote additional separation of a first fluid from a second fluid having different characteristics than the first fluid as fluid passes through mesh member 82. For example, mesh member 82 may be configured to be hydrophobic, thereby tending to separate water from another fluid, such as, for example, fuel.

As shown in FIGS. 8 and 10, second end 34 of canister 14 includes a threaded portion 129 configured to be coupled to a complimentary threaded portion 92 of collection bowl 42. Seal member 40 is pressed against collection bowl 42 when canister 14 is coupled to collection bowl 42 to provide a fluid-tight barrier between canister 14 and collection bowl 42.

As shown in FIGS. 7-15, exemplary filter assembly 10, canister 14, and filter element 16 may be configured to remove at least a portion of water (and particulates) from fuel passing through filter element 16. For example, fluid for filtration enters filter element 16 via inlet passage 26 of filter base 12, flowing through one or more inlet ports 88 of top plate 46 (see arrows 94). Inlet ports 88 are configured to direct fluid between interior surface 116 of outer tubular member 54 and exterior surface 114 of inner tubular member 58. Second end 64 of inner tubular member 58 is coupled to second end 68 of outer tubular member 54, such that the fluid is forced to pass through outer apertures 56 and from interior surface 74 of filter media 70 to exterior surface 72 of filter media 70 (see arrows 96), which promotes separation of water from fuel in the fluid (e.g., it coalesces the water as is passes through filter media 70). The water and fuel thereby enter space 78. The water, at least partially coalesced into water droplets, drops down space 78 and through one or more passages 124 between second cap 52 and canister 14, where it collects in collection bowl 42 (see arrows 98). Fuel separated from the water also passes through passages 124, but into inner tubular member 58 via mesh member 82 and inlet passages 126 (see arrows 100), either directly or after collecting atop water in collection bowl 42 as a result of the fuel not remixing with the water and having a lower density than the water. Thereafter, fuel inside inner tubular member 58 travels (under pressure) up through inner tubular member 58 to outlet passage 84 and into outlet passage 30 of filter base 12 (see arrow 101), where the filtered fuel returns to a fuel system.

According to some embodiments, for example, as shown in FIG. 8, canister 14 and filter element 16 are configured such that the portion of the fluid that flows from first side 120 of second cap 52 to second side 122 of second cap 52, but not into inner tubular member 58 (e.g., water), flows between inner tubular member 58 and outer tubular member 54 in a direction substantially parallel to longitudinal axis X of canister 14 and away from first cap 44. As shown, exemplary canister 14 and filter element 16 are also configured such that a second portion of the fluid flows into inner tubular member 58 (e.g., fuel), and the second portion flows in a direction substantially parallel to longitudinal axis X of canister 14 and toward first cap 44. The portion of the fluid that flows from first side 120 of second cap 52 to second side 122 of second cap 52, but not into inner tubular member 58, and the second portion that flows into inner tubular member 58, flow in substantially opposite directions, which may further promote the separation of the two portions of fluid (e.g., the water from the fuel).

According to some embodiments, a method for separating a first fluid from a second fluid having different characteristics than the first fluid (e.g., separating water from fuel) may include flowing a fluid including a first fluid and a second fluid from filter base 12 into filter element 16 (see, e.g., arrow 94) including filter media 70 configured to promote separation of the first fluid from the second fluid as the fluid passes through filter media 70. The method may further include flowing the fluid through filter media 70 (see, e.g., arrows 96) to separate at least a portion of the first fluid from the second fluid, and flowing the first fluid into collection bowl 42 (see, e.g., arrows 98) configured to capture the first fluid. The method according to some embodiments may also include flowing the second fluid via inner tubular member 58 out of filter element 16 and into filter base 12 (see, e.g., arrow 101). According to some embodiments, flowing the first fluid into collection bowl 42 includes flowing the first fluid in a first direction substantially parallel to longitudinal axis Y of inner tubular member 58, and flowing the second fluid out of filter element 14 includes flowing the second fluid in a second direction substantially parallel to longitudinal axis Y and opposite to the first direction. According to some embodiments, flowing the fluid through filter media 70 includes flowing the fluid in a direction transverse to the first direction and the second direction (e.g., see arrows 96). For example, the exemplary embodiment of filter assembly 10 shown in FIGS. 7-15 could be used to perform these exemplary methods.

As shown in FIGS. 8 and 10, at least portions of collection bowl 42 may be configured such that it is possible to determine the level of the fluid in collection bowl 42. For example, at least a portion of collection bowl 42 (e.g., all of collection bowl 42) may be clear or translucent so that it is possible to determine the level of water in collection bowl 42. This may permit an operator or service technician to determine whether it might be advisable to remove the fluid from collection bowl 42. This may substantially prevent enough water from accumulating in collection bowl 42 to be carried up into inner tubular member 58, through outlet passage 84 of first cap 44 and outlet passage 30 of filter base 12, and into the fuel system downstream of filter assembly 10. According to some embodiments, a sensor 102 may be provided to sense whether water should be removed from collection bowl 42. Sensor 102 may be replaced with a plug. Some embodiments of filter assembly 10 may include a drain 104 including a drain hole 106 and a drain plug 108 configured to facilitate removal of fluid (e.g., water) from collection bowl 42.

For example, as shown in FIGS. 10, 14, and 15, second cap 52 may include a boss 132 extending from second side 122 of second cap 52 forming a pocket 134 in selective flow communication with collection bowl 42. Exemplary drain plug 108 may include a threaded portion 136 configured to engage a complimentary threaded portion 138 of pocket 134. Drain plug 108 may also include an internal passage 140 configured to selectively provide flow communication between collection bowl 42 and exterior to collection bowl 42 when drain plug 108 is rotated (e.g., unscrewed) to a point at which internal passage 140 is exposed to fluid in collection bowl 42.

According to some embodiments, such as the exemplary embodiment shown in FIGS. 7-15, first cap 46 may be in the form of top plate 46 including an anti-prefill cap 142. As shown in FIGS. 9, 12, and 13, anti-prefill cap 142 is configured to reduce the likelihood that contaminated fluid enters inner tubular member 58, for example, when filter element 16 is being prepared for installation. Exemplary anti-prefill cap 142 includes a cover portion 144 spaced from an exit 146 of outlet passage 84 by a plurality of extensions 148 extending from an upper surface 150 of top plate 46. According to some embodiments, for example, as shown in FIG. 9, a nozzle 152 may extend from upper surface 150 of top plate 46. This may serve to further prevent fluid from unintentionally entering inner tubular member 58.

According to some embodiments, first cap 44 or top plate 46 may not be coupled directly to filter media 70 and/or inner tubular member 58. For example, embodiments consistent with the exemplary embodiments shown in FIGS. 7-15 may include any apparatus configured to establish fluid seals between filter element 16 and outlet passage 30 of filter base 12, such as, for example, an adaptor configured to couple a “spin-on” type filter element with filter base 12 via a threaded spin-on connection. For example, top plate 46 may be modified to include a threaded sleeve configured to engage an upper portion of a “spin-on” filter element and thereby couple the “spin-on” filter element to filter base 12 in a manner at least similar to the exemplary embodiment of top plate 46 shown in FIGS. 8, 9, 12, and 13.

### INDUSTRIAL APPLICABILITY

The exemplary filter elements and filter assemblies of the present disclosure may be applicable to a variety of fluid systems. For example, the filter elements and filter assemblies may be applicable to power systems, such as, for example, compression-ignition engines, gasoline engines, gaseous-fuel powered engines, and other internal combustion engines known in the art. For example, the filter elements and filter assemblies may be used in a fuel system, for example, to separate water from fuel and/or remove particulate matter from fuel prior to being supplied to an engine. Use of the disclosed filter elements and filter assemblies may result in a more desirable level of filtration and/or separation of water from fuel, even in circumstances where water may be particularly difficult to separate from fuel.

According to some embodiments, filter element 16 and filter assembly 10 may provide improved separation by virtue of, for example, the flow paths of the fuel and water mixture and the separated fuel and water. For example, according to some embodiments, filter media 70 may act to coalesce water as fuel including at least a small percentage of water passes through filter media 70. Thereafter, coalesced water droplets and fuel may flow in substantially the same direction toward collection bowl 42. However, the fuel is forced under pressure via inner tubular member 58 in the opposite direction toward filter base 12 and back into the fuel system. This change in direction may promote additional separation of the water and fuel as the water travels downward into collection bowl 42. Further, in embodiments including mesh member 82, mesh member 82 serves to further promote separation of any water remaining in the fuel as the fuel travels toward or up inner tubular member 58. Mesh member 82 may be hydrophobic, and thus, may tend to prevent water from passing through mesh member 82, while allowing the fuel to pass through more easily.

As a result, according to some embodiments, the filter elements and filter assemblies may improve the separation of water from fuel, for example, when water is emulsified in the fuel and/or when the fuel contains bio-components. According to some embodiments, the methods may serve a similar purpose.

It will be apparent to those skilled in the art that various modifications and variations can be made to the disclosed, exemplary filter elements, filter assemblies, and methods. Other embodiments will be apparent to those skilled in the art from consideration of the specification and practice of the disclosed examples. It is intended that the specification and examples be considered as exemplary only, with a true scope being indicated by the following claims and their equivalents.

What is claimed is:

1. A filter element comprising:
an outer tubular member having a longitudinal axis and extending between a first end and a second end, the outer tubular member including a plurality of outer apertures;
an inner tubular member at least partially inside the outer tubular member;
a first cap coupled to the first end of the outer tubular member, the first cap including a first inlet passage configured to provide flow communication into the filter element;
a second cap coupled to the second end of the outer tubular member, wherein the second cap is configured to provide flow communication from a first side of the second cap to a second side of the second cap opposite the first cap;
and
filter media configured to promote separation of a first fluid from a second fluid having different characteristics than the first fluid as fluid passes through the filter media, wherein the filter media extends between the first cap and the second cap and around an exterior surface of the outer tubular member,
wherein the first cap is configured such that fluid entering the filter element flows between an exterior surface of the inner tubular member and an interior surface of the outer tubular member, through at least some of the plurality of apertures in the outer tubular member, and through the filter media, and wherein a portion of the fluid flows from the first side of the second cap to the second side of the second cap, but does not flow into the inner tubular member.

2. The filter element of claim 1, wherein the filter element is configured such that a second portion of the fluid flows into the into the inner tubular member.

3. The filter element of claim 1, wherein the inner tubular member includes a tubular wall extending in a direction substantially parallel to the longitudinal axis of the outer tubular member, and wherein the tubular wall does not include apertures.

4. The filter element of claim 1, wherein the filter element is configured to be received in a canister such that a space is provided between the canister and an exterior surface of the filter media, and wherein the second cap is configured to provide flow communication between the space and the second side of the second cap opposite the filter media.

5. The filter element of claim 1, wherein the second cap includes a plurality of legs extending from a side of the second cap opposite the filter media.

6. The filter element of claim 5, further including a mesh member at least partially covering the legs such that fluid flowing from the second side of the second cap to a second inlet passage passes through the mesh member, wherein the mesh member is configured to promote separation of a first fluid from a second fluid having different characteristics than the first fluid, as fluid passes through the mesh member.

7. The filter element of claim 6, wherein the mesh member is configured to be hydrophobic.

8. The filter element of claim 1, wherein the first cap includes a top plate, and wherein the top plate is configured to direct fluid entering the filter element to flow between the interior surface of the outer tubular member and the exterior surface of the inner tubular member.

9. The filter element of claim 1, wherein the first cap includes a seal member configured to provide a fluid seal between the first cap and a filter base.

10. The filter element of claim 1, wherein the filter media is configured such that water in the fluid coalesces as the fluid passes from the exterior surface of the outer tubular member to the exterior surface of the filter media.

11. The filter element of claim 1, wherein the filter element is configured such that the portion of the fluid flow that flows from the first side of the second cap to the second side of the second cap, but does not flow into the inner tubular member, flows in a direction substantially parallel to the longitudinal axis of the outer tubular member and away from the first cap.

12. The filter element of claim 1, wherein the filter element is configured such that a second portion of the fluid flows into the inner tubular member, and the second portion flows in a direction substantially parallel to the longitudinal axis of the canister and toward the first cap.

13. A filter assembly comprising:
a canister having a longitudinal axis and extending between a first end and a second end of the canister;
a filter element received in the canister, the filter element including:
an outer tubular member having a longitudinal axis and extending between a first end and a second end, the outer tubular member including a plurality of outer apertures;
an inner tubular member at least partially inside the outer tubular member;
a first cap coupled to the first end of the outer tubular member, the first cap including a first inlet passage configured to provide flow communication into the filter element;
a second cap coupled to the second end of the outer tubular member, wherein the second cap is configured to provide flow communication from a first side of the second cap to a second side of the second cap opposite the first cap;
and
filter media configured to promote separation of a first fluid from a second fluid having different characteristics than the first fluid as fluid passes through the filter media, wherein the filter media extends between the first cap and the second cap and around an exterior surface of the outer tubular member,
wherein the first cap is configured such that fluid entering the filter element flows between an exterior surface of the inner tubular member and an interior surface of the outer tubular member, through at least some of the plurality of apertures in the outer tubular member, and through the filter media, and wherein a portion of the fluid flows from the first side of the second cap to the second side of the second cap, but does not flow into the inner tubular member; and
a collection bowl coupled to the second end of the canister and configured to receive the portion of the fluid flow that flows from the first side of the second cap to the second side of the second cap but does not flow into the inner tubular member.

14. The filter assembly of claim 13, further including a filter base configured to be coupled to a machine and the first end of the canister.

15. The filter assembly of claim 14, wherein the first cap includes a top plate, wherein the top plate is configured to direct fluid entering the filter element from the filter base to flow between the exterior surface of the inner tubular member and the interior surface of the outer tubular member.

16. The filter assembly of claim 13, wherein the second end of the canister includes a threaded portion coupled to the collection bowl.

17. The filter assembly of claim 13, wherein the filter media is configured such that water in the fluid coalesces as the fluid passes from an exterior surface of the outer tubular member to the exterior surface of the filter media and collects in the collection bowl.

18. A method for separating a first fluid from a second fluid having different characteristics than the first fluid, the method comprising:
flowing a fluid including a first fluid and a second fluid from a filter base into a filter element including filter media configured to promote separation of the first fluid from the second fluid as the fluid passes through the filter media;
flowing the fluid through the filter media to separate at least a portion of the first fluid from the second fluid;
flowing the first fluid into a collection bowl configured to capture the first fluid; and
flowing the second fluid via an inner tubular member out of the filter element and into the filter base.

19. The method of claim 18, wherein the inner tubular member has a longitudinal axis, and wherein flowing the first fluid into the collection bowl includes flowing the first fluid in a first direction substantially parallel to the longitudinal axis, and flowing the second fluid out of the filter element includes flowing the second fluid in a second direction substantially parallel to the longitudinal axis and opposite to the first direction.

20. The method of claim 19, wherein flowing the fluid through the filter media includes flowing the fluid in a direction transverse to the first direction and the second direction.
